(19) United States
(12) Patent Application Publication
(10) Pub. No.: US 2007/0058819 A1
(43) Pub. Date: Mar. 15, 2007

(54) Portable audio player and method for selling same

(75) Inventors: Kenneth B. Hertz, Beverly Hills, CA (US); Jemmy Chi-Keung Fung, Hong Kong (CN)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: Membrain,LLC

(21) Appl. No.: 11/227,315

(22) Filed: Sep. 14, 2005

(51) Int. Cl. H04R 1/10

(52) U.S. Cl. 381/74

(57) ABSTRACT

A self-contained, self-executing digital audio player that includes a casing, a memory disposed in the casing, a power source disposed in the casing, and a sound jack disposed in an opening in the casing. The memory is preprogrammed with a predetermined audio selection, and a user cannot change the audio once the memory has been preprogrammed.

### FIELD OF THE INVENTION

The present invention relates generally to a portable digital audio player, and more particularly, to a portable digital audio player that is compact and includes a preprogrammed memory.

### BACKGROUND OF THE INVENTION

Conventionally, a variety of digital audio players including MP3 players have been manufactured and marketed. However, such digital audio players are often expensive and are difficult for the average consumer to program with their favorite music. Travelers often use digital audio players. However, some digital audio players are bulky and travelers often forget to bring their digital audio player on a trip. Accordingly, a need exists for a compact, inexpensive, easy to use digital audio player that includes preprogrammed audio already loaded in the memory of the player. For example, such a digital audio player could be sold at an airport.

### SUMMARY OF THE PREFERRED EMBODIMENTS

In accordance with a first aspect of the present invention, there is provided a digital audio player including a first ear casing that includes a memory and a speaker. The memory is preprogrammed with a predetermined audio selection, such as an album, and the audio content preferably cannot be changed once the memory has been preprogrammed. The player can also include a second ear casing that includes a power source, and a second speaker. The first and second ear assemblies are preferably in electrical communication. In a preferred embodiment the player also includes a microcontroller and a signal processor.

In accordance with another aspect of the present invention there is provided a method of selling a predetermined composition of audio. The method includes the steps of manufacturing a digital audio player with a programmable memory, programming the memory of the digital audio player with the predetermined composition of audio during the manufacturing process, and selling the digital audio player to a consumer. The predetermined composition of audio preferably cannot be erased from the memory.

In accordance with another aspect of the present invention there is provided a digital audio player that includes a casing, a memory disposed in the casing, a power source disposed in the casing, and a sound jack disposed in an opening in the casing. The memory is preprogrammed with a predetermined audio selection, and the audio cannot be changed once the memory has been preprogrammed. In a preferred embodiment the sound jack defines a diameter and the casing defines a thickness, and the diameter of the sound jack and the thickness of the casing are substantially similar.

### BRIEF DESCRIPTION OF THE DRAWINGS

The invention may be more readily understood by referring to the accompanying drawings in which:

FIG. 1 is a perspective view of the first and second ear casings of a digital audio player in accordance with a first preferred embodiment of the present invention;

FIG. 2 is an exploded perspective view of the first and second ear casings of FIG. 1;

FIG. 3 is a conceptual view showing the internal configuration of the digital audio player of FIG. 1;

FIG. 4 is a perspective view of the first and second ear casings of a digital audio player in accordance with another preferred embodiment of the present invention;

FIG. 5 is an exploded perspective view of the first and second ear casings of FIG. 4;

FIG. 6 a perspective view of a digital audio player in accordance with another preferred embodiment of the present invention;

FIG. 7 is an exploded perspective view of the digital audio player of FIG. 6;

FIG. 8 is a perspective view of the digital audio player of FIG. 6 with an earphone compartment and a set of earphones added thereto;

FIG. 9 is a perspective view of a digital audio player in accordance with another preferred embodiment of the present invention; and

FIG. 10 is an exploded perspective view of the player of FIG. 9.

Like numerals refer to like parts throughout the several views of the drawings.

### DETAILED DESCRIPTION OF THE PREFERRED EMBODIMENTS

In a preferred embodiment, the digital audio player is a small plastic module that contains non-volatile, solid-state memory that is preprogrammed with a predetermined composition of audio that cannot be changed by the end user. The player is self-executing in that a user can purchase the player and immediately begin listening to the pre-programmed audio content thereon without need for a separate player.

For exemplary purposes only, described hereinbelow are preferred embodiments wherein the memory of the digital audio player includes a single album (e.g., a collection of musical compositions by a single artist or a group of artists). For example, the memory may contain the album X&Y by Coldplay, the soundtrack to the film Gladiator or the like. However, it will be understood, that the pre-programming of a single album into the memory of the digital audio player is not a limitation on the present invention. For example, the memory can contain a single song, spoken word (e.g., a book), or a pre-selected assortment of songs or other material chosen by the consumer, etc.

It will be appreciated that terms such as “front”, “back” and “side” used hereinbelow are merely for ease of description and refer to the orientation of the components as shown in the FIGS. It should be understood that any orientation of the digital audio player and the components thereof described herein is within the scope of the present invention.

Generally, the player includes any or all of the following components—memory, a microprocessor/microcontroller, a digital signal processor or codec, a display, playback controls, an audio port or sound jack, an amplifier, and a power supply. Those skilled in the art are familiar with the basic components of a digital audio player.

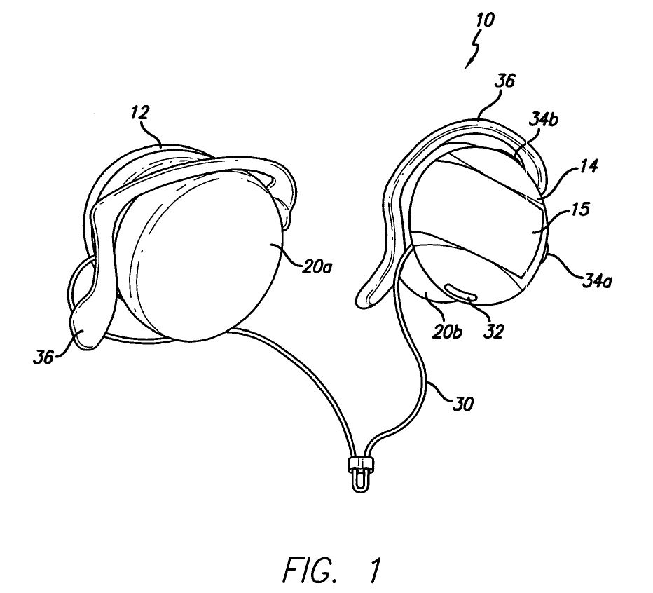

A preferred embodiment of the present invention is shown in FIGS. 1-3. Generally, the digital audio player 10 includes first and second ear casings 12 and 14. As shown in FIG. 1, the second ear casing contains a power source 16, which is preferably a battery of sufficient voltage to power the speaker and chip for a desired number of hours of play. The battery may also be rechargeable, such as a nickel-cadmium type rechargeable battery or the like. The player 10 may be adapted to plug into a wall outlet or USB port to recharge the battery or the power source 16 may be provided by an alternating current source, such as a wall outlet. The second ear casing 14 has a door 15 that provides access to the battery for changing it.

The power source 16 powers first and second speakers 18a and 18b. First speaker 18a is located in the first ear casing 12 and second speaker 18b is located in the second ear casing 14. The speakers generate sound from signals stored and reproduced by electrical components within the first ear casing 12. It will be understood that the components housed in the first ear casing 12 can be housed in the second ear casing 14 and vice versa.

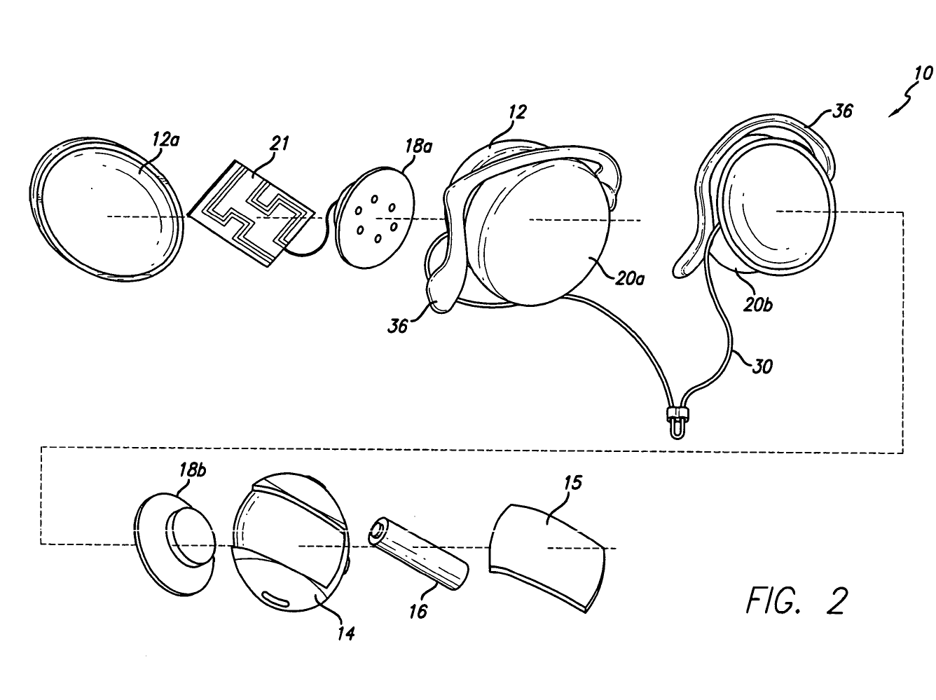

In a preferred embodiment, as shown in FIG. 2, the casings 12 and 14 each include a speaker housing 20a and 20b that houses the speakers 18a and 18b. For the comfort of the user, the speaker housings 20a and 20b can include some type of soft material thereon.

The components housed in the first ear casing 12 are in electrical communication with the power source 16. They are also in electrical and logical communication with first and second speakers 18a and 1 8b.

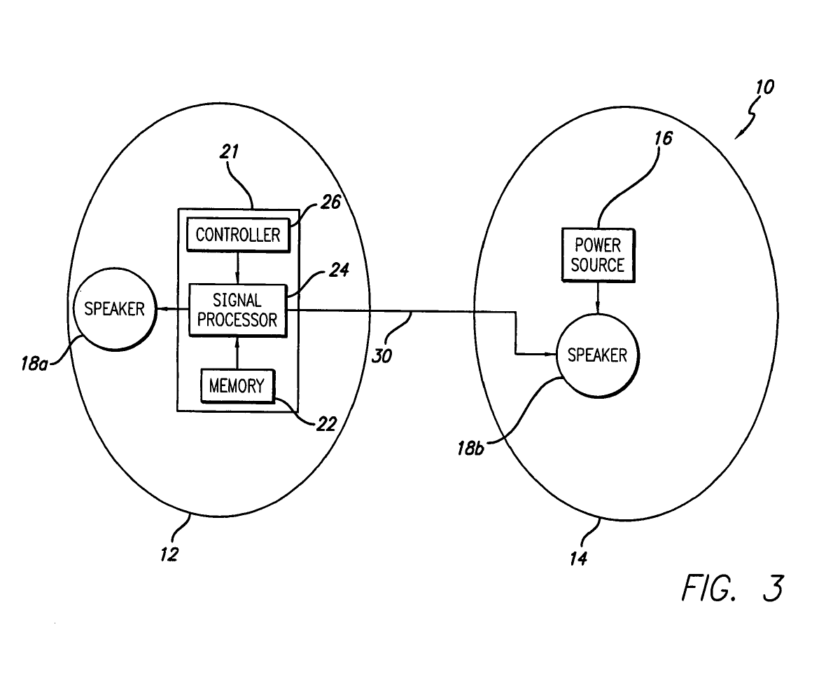

The primary electrical components housed in the first ear casing 12 (most of which are included on a printed circuit board 21) include memory 22 for storing digital audio data in a non-volatile way, a signal-processor 24 for decoding digital audio signals to generate analog sound signals, and a microcontroller 26 for controlling the entire system operation. As shown in FIG. 2, the first ear casing 12 can contain a cover portion 12a for containing the PCB and remainder of the “guts” of the first ear casing 12. For simplicity in the figures, except for FIG. 3, the electrical components described above, such as the memory, microprocessor/microcontroller, digital signal processor or codec, amplifier, etc. are omitted, and the PCB 21 is shown. It will be understood that the PCB 21 may contain some or all of these components.

In a preferred embodiment, the memory 22 is non-erasable flash RAM. However, the non-erasable flash memory is presented as an example of a non-volatile memory module for storing digital audio data, but various non-volatile memory devices may be used, in addition to the non-erasable flash memory device. For example, the memory can also be ROM. Preferably, the memory 22 is programmed during the manufacturing process, and, cannot be changed or erased by the end user. In an alternative embodiment, the memory 22 can be erasable flash RAM or the like, such as a CompactFlash card, a SmartMedia card, a Memory Stick or an internal microdrive, or the memory can be interchangeable ROM.

The digital audio data is fed from memory 22 through signal processor 24, which generates analog sound signals that are provided to speakers 18a and 18b or, in an alternative embodiment, an audio port or sound jack. The signal processor 24 is preferably an MPEG layer 3 audio decoder that includes a digital to analog converter or the like. It is also preferable for the decoder to have an earphone amplifier to eliminate the need for a separate amplifier in the player. However, a separate amplifier in the player can also be provided. A chip that contains a high-performance, low power digital signal processor core and high quality oversampling variable sample rate digital to analog converter is preferred.

The microcontroller 26 is preferably a low power CMOS such as an 8-bit microcontroller based on RISC architecture. This achieves high throughputs while minimizing power consumption. However, other microcontrollers can also be used. It will be understood that FIG. 3 is only an example of the inner workings of the digital audio player (and the components of the PCB 21 in the first ear casing). Those skilled in the art will be able to make numerous changes to how the digital audio player and it's components, such as the microncontroller, signal processor, memory, etc. work and interact.

In a preferred embodiment, the player 10 includes a number of user entered device control commands that are controlled by the microcontroller 26. For example, the first ear casing preferably includes a button 32 for controlling ON/OFF and PLAY/PAUSE. The button 32 is in communication with the microcontroller 26. In operation, a short press is for ON/OFF and a long press is for PLAY/PAUSE. The length of time for which the button 32 needs to be pressed to actuate the different functions is predetermined. Preferably, the player 10 also includes buttons 34a and 34b for volume control and going forward and backward from song to song. In operation, a short press is for FORWARD and BACKWARD and a long press is for volume control.

The player 10 can alternatively include separate buttons for each of these functions or for other functions, including, but not limited to, a graphic equalizer and other functions known by those skilled in the art. The volume regulator may be continuously variable or variable by steps such as low, medium and high. The volume regulator may also incorporate the power switch that turns the device on and off. Alternatively, the player 10 may have a display, such as an LCD display, indication lights and/or other accessories.

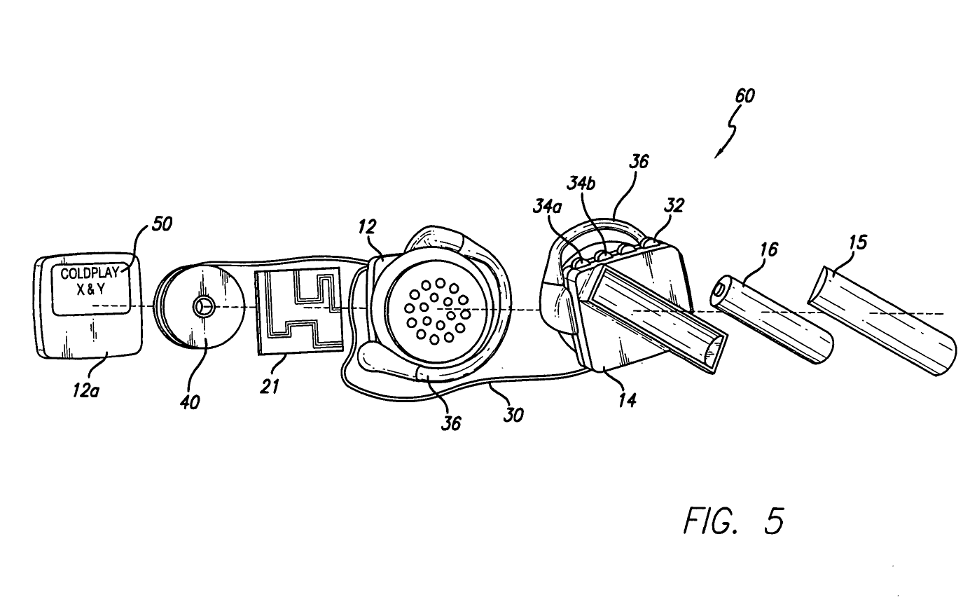

As shown in FIGS. 2 and 3, a connecting member 30 (preferably an insulated wire(s)) electrically connects the first and second ear casings 12 and 14 to supply operating power from the second ear casing 14 to the first ear casing 12 and analog sound signal from the first ear casing 12 to the second ear casing 14. In an alternative embodiment, the connecting member 30 may be retractable into one of the first or second ear casings 12 and 14 (see FIG. 5).

The first and second ear casings 12 and 14 can be held on the user's ears by any known method. As shown in the figures, in a preferred embodiment, the first and second ear casings 12 and 14 each include an ear hook 36. The ear hooks 36 are preferably spring biased so that they conform to any number of different users' ears. It will be understood that the use of ear hooks is not a limitation on the present invention, but that any known method of holding earphones in place can be used. For example, the first and second ear casings 12 and 14 may be held on a user's head by a U-shaped member, as is well known in the art.

The digital audio player described herein is small, compact and simple in design with no internal moving parts. As discussed above, the digital audio content contained in the memory is programmed during the manufacturing process. In a typical digital audio player, a user has to program audio into the memory after it has been purchased. An advantage of the present invention is that the user can purchase the player at a relatively inexpensive price and immediately begin listening to the audio content contained in the pre-programmed memory. For example, a person at the airport decides that they would like to listen to the album X&Y by Coldplay during their flight, but they do not have any type of music player with them. With the present invention that person can walk into a store located at the airport, purchase the digital audio player with X&Y already pre-programmed in the memory and immediately begin listening to the album.

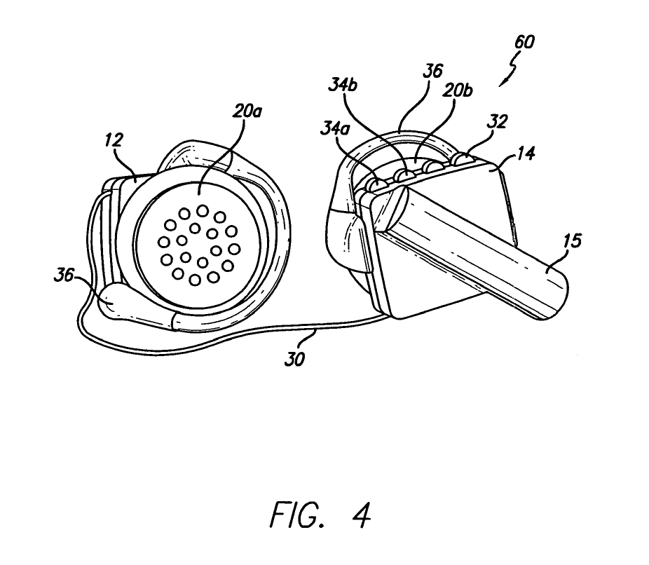

FIGS. 4-5 show another embodiment of a digital audio player 60 that is similar to player 10, but includes relatively square first and second ear casings 12 and 14. In this embodiment, connecting member 30 is retractable and can be wound up on a spring-biased spool 40.

As shown in FIG. 5, the present invention can include graphics 50 or other indicia on the outside thereof that indicate what album or other content the player contains. In one embodiment, the player can include indicium that identifies the audio content stored in the memory of the player. In another embodiment, the player can include indicia for identifying the specific album stored in the memory.

Also, in another embodiment, the user can pre-order what content they want on the player before it is manufactured. As a result, after ordering and manufacturing, the user will have a self-executing/self contained digital audio player with content that he/she requested. For example, the user may log on to a website, purchase a digital audio player, and select a list of songs that they would like to purchase. The seller then programs the memory of the digital audio player with the ten chosen songs, and then ships the player to the user.

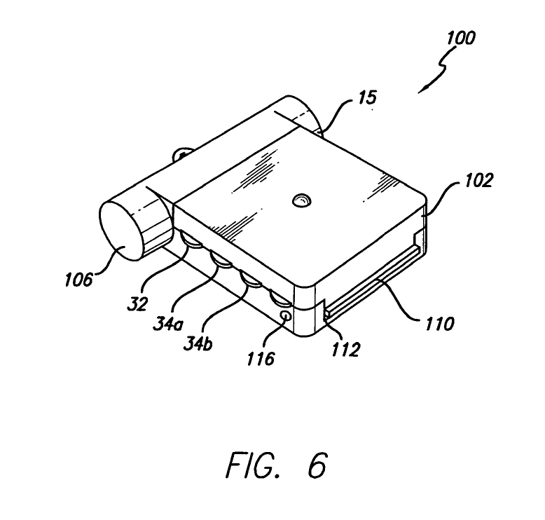

A second preferred embodiment of a digital audio player 100 is shown in FIGS. 6-8. Generally, player 100 includes a main body portion 102, which houses the electronic components 104 (which are all preferably contained on a printed circuit board 21), and a battery portion 106, which houses the power source 16. In a preferred embodiment, the power source 16 is a disposable battery. However, it will be understood that the power source can also be a rechargeable battery, an alternating current source, solar power or any other type of known power source.

Player 100 generally utilizes the same electrical components as player 10, described above. Accordingly, a description of the electrical components 104 of player 100, such as the signal processor and microcontroller, etc., will be omitted. Although, any type of flash RAM, ROM or any other type of memory can be used for player 100, in the exemplary embodiment shown in the figures, player 100 utilizes a MultiMediaCard 110 (referred to hereinafter as “MMC”) for memory storage. These cards are extremely lightweight and small. Since these cards are non-volatile solid-state, there are no moving parts, which minimizes power consumption. Also data is not lost if power is lost. The cards are robust and sturdy and able to withstand abusive conditions. The MMC 110 is housed in the main body portion 102 and may be removable by the user. Also, the memory can be erasable or non-erasable. Preferably, the main body portion 102 includes a door 112 that provides access to the MMC 110 and the battery portion 106 includes a door 15 that provides access to the power source 16.

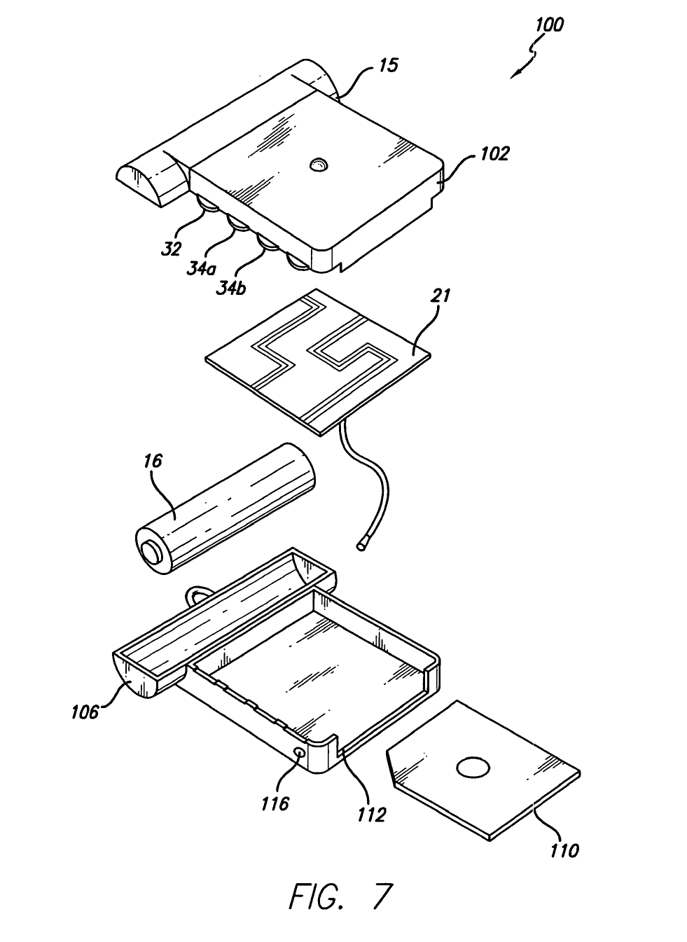

As shown in FIG. 7, player 100 includes a sound jack 116. Since a sound jack is well known to those skilled in the art, a detailed description thereof will be omitted herein. In another embodiment, the sound jack 116 can be used to recharge the battery if a rechargeable battery is used. In this embodiment, one end of the recharge chord can be plugged in to the sound jack, which is in electrical communication with the battery, and the other end of the recharge chord can be plugged in to a power source, such as a wall outlet or a USB port.

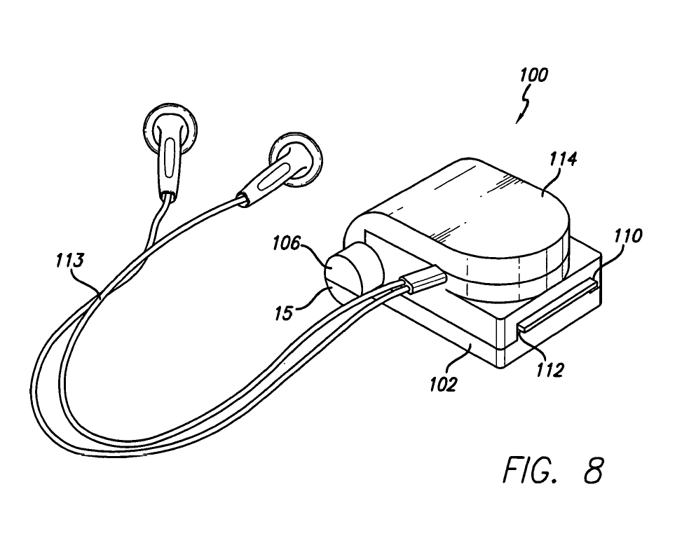

As shown in FIG. 8, in another embodiment, player 100 includes a set of earphones 113. The earphones can be either retractable or non-retractable. In a preferred embodiment, as best shown in FIG. 8, player 100 includes an earphone compartment 114 that holds the set of earphones and their associated wires. The earphones 113 may be retractable by the press of a button. Since retractable cord technology is well known to those skilled in the art, a detailed description thereof will be omitted herein.

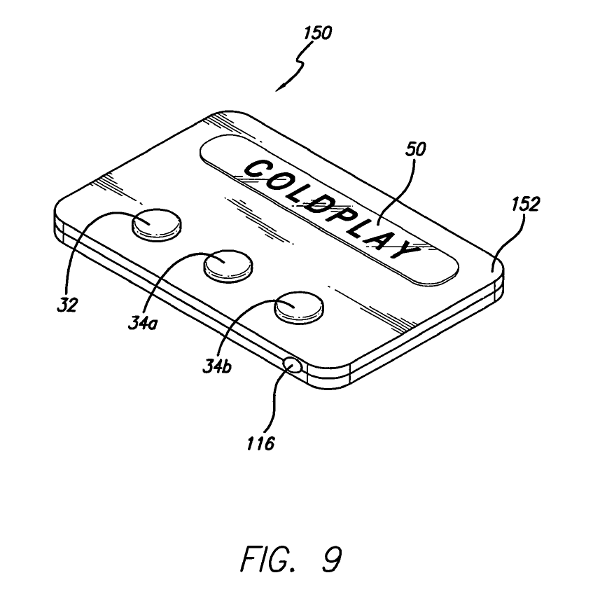

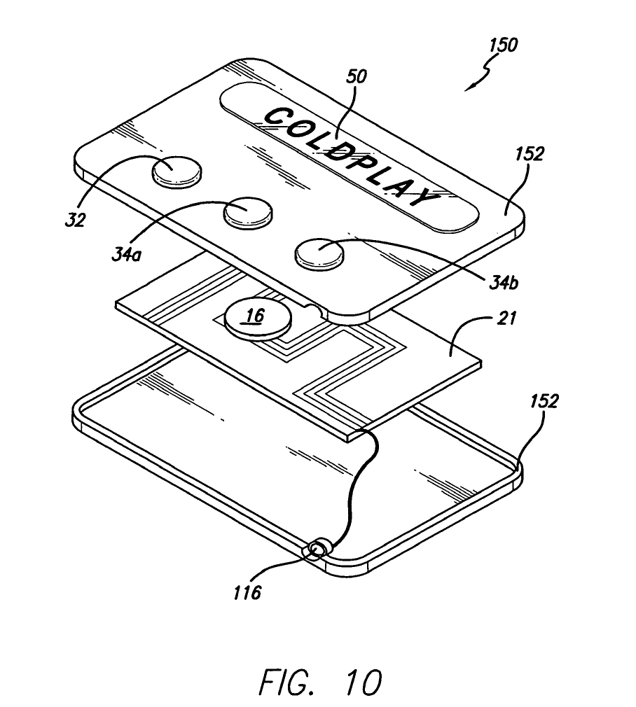

A third preferred embodiment of a digital audio player 150 is shown in FIGS. 9-10. In this embodiment, the player 150 includes a casing 152, a power source 16 (preferably a rechargeable battery or thin disposable battery) and a plurality of electrical components (similar to those described above), such as memory, a microprocessor/microcontroller, a digital signal processor or codec, a display, playback controls, and/or an amplifier. Preferably, most of the electrical components are included on a printed circuit board 21.

As can be seen in FIG. 9, player 150 is relatively thin. In use, the player 150 is intended to slip easily into a user's pocket or even a wallet. Accordingly, the components that make up the player 150 are arranged so that the casing 152 is as thin as possible. Casing 152 includes a sound jack 116 on a side thereof (which may be used for recharging the battery). In a specific embodiment, the diameter of the sound jack 116 dictates the thickness of the casing 152. In another embodiment, the player 150 may include headphones that are sold with the player. The headphones may be removable from the sound jack 116 or may be permanent.

In a preferred embodiment, the player 150 also includes at least one button (for example, buttons 32, 34a and 3 4b, as described above) in electrical communication with the playback controls. Because the player 150 is relatively thin, the buttons are also preferably thin and do not add a lot to the overall thickness of the player 150. Any type of button known in the art can be used. For example, the buttons may be touch sensitive or only require a stroke of only a couple of millimeters to be actuated.

In a preferred embodiment, the player 150 includes preprogrammed audio that is programmed into the memory of the player before it is placed at a point of sale. Once a consumer or user purchases the player 150, the audio contained in the memory cannot be erased or otherwise changed. The player 150 also preferably includes graphics 50 thereon. The graphics 50 may indicate what audio content is contained in its memory.

In operation, the player 150 could be carried in a user's wallet when not in use. When the user desires to listen to the audio content contained in the memory of the player 150 the user removes the player 150 from his/her wallet, plugs in a set of ear phones into the sound jack 116, presses the play button 32 and begins to enjoy the audio content. As discussed above, the audio content preprogrammed in the memory cannot be changed. Accordingly, in order for the user to listen to different audio selections the user must purchase different players 150.

For example, similar to purchasing CD's containing different albums or selections, the user may purchase three separate players, one containing the album X&Y by Coldplay, another containing the album How to Dismantle an Atomic Bomb by U2, and a third containing the album American Idiot by Greenday. A single set of headphones 113 can be used interchangeably between the different players 150.

The embodiments described above are exemplary embodiments of the present invention. Those skilled in the art may now make numerous uses of, and departures from, the above-described embodiments without departing from the inventive concepts disclosed herein. Accordingly, the present invention is to be defined solely by the scope of the following claims.

What is claimed is:

1. A digital audio player comprising:
a first ear casing including
a memory, wherein the memory is preprogrammed with a predetermined audio selection, and wherein the audio cannot be changed once the memory has been preprogrammed, and
a speaker;
a second ear casing including
a power source, and
a speaker;
wherein the first and second ear assemblies are in electrical communication.

2. The digital audio player of claim 1 wherein the first and second ear casings are in electrical communication via a wire.

3. The digital audio player of claim 2 wherein the first ear casing includes a signal processor.

4. The digital audio player of claim 3 wherein the first ear casing includes a microcontroller.

5. A method of selling a composition of audio, the method comprising the steps of:
manufacturing a digital audio player having a memory;
programming the memory with the composition of audio during the manufacturing process; and
selling the digital audio player to a consumer, wherein the consumer cannot erase the composition of audio from the memory or add anything new to the memory.

6. The method of claim 5 further comprising the step of placing the digital audio player at a point of sale.

7. The method of claim 5 wherein the composition of audio is an album.

8. The method of claim 6 wherein the point of sale is located at an airport.

9. The method of claim 5 further comprising the step of having the consumer determine the selection of the composition of audio.

10. The method of claim 5 wherein the digital audio player includes content identifying indicia thereon.

11. The method of claim 7 wherein the digital audio player includes album-identifying indicia thereon.

12. The method of claim 5 wherein the digital audio player includes a sound jack.

13. A digital audio player comprising:
a casing,
a memory disposed in the casing, wherein the memory is preprogrammed with a predetermined audio selection, and wherein the audio cannot be changed once the memory has been preprogrammed,
a power source disposed in the casing, and
a sound jack disposed in an opening in the casing.

14. The digital audio player of claim 13 wherein the composition of audio is an album.

15. The digital audio player of claim 14 wherein the digital audio player includes album-identifying indicia thereon.

16. The digital audio player of claim 13 wherein the composition of audio is chosen by a user.

17. The digital audio player of claim 16 wherein the digital audio player includes content identifying indicia thereon.

18. The digital audio player of claim 13 wherein the sound jack defines a diameter and the casing defines a thickness, and wherein the diameter of the sound jack and the thickness of the casing are substantially similar.
